(19) United States
(12) Patent Application Publication
(10) Pub. No.: US 2026/0335977 A1
(43) Pub. Date: Oct. 29, 2026

(54) A METAL THREE-DIMENSIONAL PRINTER

(71) Applicant: Mustafa Celal YUCA, Gebze, Kocaeli (TR)

(72) Inventor: Mustafa Celal YUCA, Gebze, Kocaeli (TR)

(21) Appl. No.: 19/106,945

(22) PCT Filed: Mar. 5, 2024
(86) PCT No.: PCT/TR2024/050204

§ 371 Date: Feb. 26, 2025

(30) Foreign Application Priority Data
Dec. 22, 2023 (TR) 2023/018023

(51) Int. Cl. B22F 10/25; B22F 12/30; B22F 12/41; B33Y 10/00; B33Y 30/00

(52) U.S. Cl. CPC B22F 10/25; B22F 12/30; B22F 12/41; B33Y 10/00; B33Y 30/00

(57) ABSTRACT

The invention relates to a metal three-dimensional printer which allows the desired metal parts to be printed faster, makes it possible to obtain stronger metal structures by printing different materials in the same part, prevents the use of extra fasteners to connect the additional parts such as rollers and bearings to a main part, makes it possible to use the printed metal part immediately after printing, increases the strength of the printed part while reducing the weight thereof, and increases the heat emitted during the printing process and thus makes it possible to attach the plastic parts to the metal parts without any damage while printing the metal parts, wherein the metal three-dimensional printer is suitable for domestic use as it does not emit heat, and also for use in gravity/zero-gravity environments and prevents waste of printing raw materials.

### TECHNICAL FIELD OF THE INVENTION

The invention relates to a metal three-dimensional printer which allows the desired metal parts to be printed faster, makes it possible to obtain stronger metal structures by printing different materials in the same part, prevents the use of extra fasteners to connect the additional parts such as rollers and bearings to a main part, makes it possible to use the printed metal part immediately after printing, increases the strength of the printed part while reducing the weight thereof, and increases the heat emitted during the printing process and thus makes it possible to attach the plastic parts to the metal parts without any damage while printing the metal parts, wherein the metal three-dimensional printer is suitable for domestic use as it does not emit heat, and also for use in gravity/zero-gravity environments and prevents waste of printing raw materials.

### STATE OF THE ART

Three-dimensional printing is a process of producing a three-dimensional designed virtual object from materials such as polymers, composites and resins by a thermal or chemical treatment. The devices performing this process are called three-dimensional printers. Prints may be made by using many types of raw materials. In the state of the art, raw materials such as polymers, composites and resins are used so as to obtain a three-dimensional virtual object, as well as metal materials are preferred as raw materials. Especially in the field of defense, the metal three-dimensional printers are widely used, and the leading defense industry companies have focused their investments on the three-dimensional printers. Considering the short lead times and material efficiency, the defense and aerospace industry, where precious and difficult-to-process metals such as titanium are used, has quickly adapted to this technology. Companies such as General Electric, Rolls Royce, Airbus, Safrane are also pioneer the use of metal 3D printer technology. Today, the works produced by metal three-dimensional printers turn into a product beyond a prototype. Consequently, thanks to the metal three-dimensional printers, the disadvantages in terms of making the product in 8-10 steps by traditional methods and therefore problems such as lifespan, risk and cost are eliminated[1].

Although metal three-dimensional printers in the state of the art provide solutions to many problems, they also cause other problems. The metal three-dimensional printers in the present art have very low printing speeds, and it takes hours to print a metal part. For example, a plastic object of 50 mm³ may be printed in 3 hours on a standard screw printer, while it may be printed in 30 minutes on a delta printer. The same object may be printed on a metal printer in an average of 2 hours.

Another problem encountered in metal three-dimensional printers in the present art is that the mechanical strength of the metal three-dimensional products printed by the metal three-dimensional printers in the state of the art is low. In the present art, the mechanical strength decreases as a result of the thermal stresses that occur during the printing of a metal object by a plasma melting method and the reaction of oxygen in the atmosphere with the printed hot object.

The lifespan of a printer is shortened due to the fact that some types of printers (especially screw and delta printers) in the state of the art provide the printing process using movable mechanisms. In such printers, mechanisms with high friction, such as gear wheels, screw systems and belts, are used to move hot nozzles.

The metal three-dimensional printers in the present art occupy a large place. The fact that a metal three-dimensional printer occupies a large place limits the usage area of printers. In a laser melting printer in the present art, the powder, the raw material of printing, is accumulated in a pool, and said pool is filled to the maximum level regardless of which object is being printed, and this increases the size of said printer to the size of an average domestic washing machine. In addition, laser printers in the state of the art have a laser generator unit in a size of a printing chamber to obtain the laser beam responsible for melting the metal during the printing process. In addition, in a printer using the plasma nozzle melting method, a plasma generator, the hose lines for transporting the metal to be melted and the robotic arm mechanisms used in mass production lines, for the movement of the melting nozzle are used.

The metal three-dimensional printers in the state of the art are highly costly, which restricts easy access to printers.

Plasma nozzles are used in the metal three-dimensional printers in the present art, and these printers are not suitable for domestic use as they emit excess heat. The main source of the aforementioned problem is the need to melt raw materials for the object to be printed. Especially since the melting temperatures of metals are high, high thermal energy is needed, and as the densities of metals are higher than plastics, etc., they store high thermal energy and this thermal energy is emitted to the environment during and after the printing process. The metal part printed in metal three-dimensional printers in the state of the art is not possible to be used immediately due to the temperature thereof.

After the metal parts are printed in the metal three-dimensional printers in the present art, the plastic parts are not possible to be attached to the metal parts obtained without any damage. In the metal three-dimensional printers in the present art, the surface temperature of the printed object may rise up to 500 to 2000 degrees during the printing process. Since an object at these temperatures can easily melt the plastic-based materials, it is not possible for a plastic-based material to contact with a metal object printed by the existing systems.

The metal three-dimensional printers are not possible to be used in a zero-gravity environment. The use of a metal three-dimensional printer, especially in the zero-gravity environments, has started to gain more importance with the developing technology. For example, it may not be possible to access all kinds of materials in a spacecraft, and a metal three-dimensional printer will be very important in spacecraft in order to meet the needs instantly.

There is a need for a metal three-dimensional printer in which all problems are eliminated, due to the facts that the metal three-dimensional printers in the state of the art are limited and insufficient, the printing speeds of the metal three-dimensional printers in the present art are low enough to last for hours, the mechanical strength of the metal three-dimensional products printed by metal three-dimensional printers in the state of the art is low, the number of movable parts of the printed products is high and therefore the printer lifespan is very low, the metal three-dimensional printers in the present art occupy a big place, the metal three-dimensional printers in the state of the art are highly costly, which prevents easy access to the printers, the metal three-dimensional printers in the present art emit excess heat and therefore said printers are not suitable for domestic use, the metal part printed on the metal three-dimensional printers in the state of the art cannot be used immediately due to the temperature thereof, and the plastic parts are not possible to be attached to the metal parts obtained without any damage after the metal parts are printed in the metal three-dimensional printers in the present art.

### SUMMARY AND OBJECTS OF THE INVENTION

The invention discloses a metal three-dimensional printer which allows the desired metal parts to be printed faster, makes it possible to obtain stronger metal structures by printing different materials in the same part, prevents the use of extra fasteners to connect the additional parts such as rollers and bearings to a main part, makes it possible to use the printed metal part immediately after printing, increases the strength of the printed part while reducing the weight thereof, and increases the heat emitted during the printing process and thus makes it possible to attach the plastic parts to the metal parts without any damage while printing the metal parts, wherein the metal three-dimensional printer is suitable for domestic use as it does not emit heat, and also for use in gravity/zero-gravity environments and prevents waste of printing raw materials, wherein the metal three-dimensional printer comprises a powder chamber, an electrode, copper accelerator coils connected to the chamber as a row arranged on a plastic pipe, a high voltage particle accelerator consisting of two plates, a lid through which the metal powder is filled into the powder chamber, a metal platform, a bundle former on which an electromagnet is located, an accelerator complex, a cylindrical printer wall, electromagnetic deflectors mounted on the same line, and a vacuum connection line.

An object of the invention is to provide a metal three-dimensional printer with a high printing speed. Time is saved due to the high printing speed of the metal three-dimensional printer of the invention. The metal three-dimensional printer of the invention offers a printing speed at least 5 times faster than a metal three-dimensional printer in the state of the art. In printer systems in the present art, the printing process consists of a single print head, while in the metal three-dimensional printer of the invention, the number of the print heads start from four and increases to an unlimited number as the printer size increases.

The invention provides a metal three-dimensional metal printer which enables three-dimensional metals with high mechanical strength to be printed. The metal three-dimensional printer of the invention prints a product by a method of accumulating metals in powder form in layers on top of each other. Mechanical strength is increased due to the fact that other strength-enhancing metals may be added to the metal in powder form during printing, and as a result, the metallic structure of each layer of the object to be printed may be designed depending on the charges loaded on the object.

The invention provides a metal three-dimensional printer with a high lifespan. The metal three-dimensional printer of the invention uses electromagnetic principles to accelerate the metal powder used to print a metal object and to provide the object in the desired form. Therefore, the metal three-dimensional printer of the invention does not contain movable mechanisms, and as long as the parts are kept at the correct temperatures, the system lifespan increases to the unlimited levels.

Another object of the invention is to provide a metal three-dimensional printer with a reduced volumetric area. Electromagnetic accelerators are used in the metal three-dimensional printer of the invention. These accelerator mechanisms may be easily disassembled, folded and even embedded in the environment to be used. Due to these features, the metal three-dimensional printer of the invention occupies a small place in volume.

The invention provides a low-cost metal three-dimensional printer. The parts used in my invention are materials with standard dimensions and specifications. You may easily obtain these materials and produce printers. For example, the copper coil used in the accelerator mechanism has also the same properties as the coils produced for electric motors.

The invention provides a metal three-dimensional printer suitable for domestic use. The metal three-dimensional printer of the invention may be used even domestically as it does not emit excess heat during printing. The metal three-dimensional printer of the invention enables melting to occur only on the metal surfaces in the contact area instead of melting all of the metal raw material for the object to be printed, thus reducing the need for thermal energy and reducing the temperature measured in the environment to safe levels (below 100 degrees). The main source of the problem is the need to melt the raw materials for the object to be printed; especially as the melting temperatures of metals are high, high thermal energy is needed, and as the densities of metals are higher than plastics, etc., they store high thermal energy, so this thermal energy is emitted to the environment during and after the printing process. In addition, the fact that the printed metal part cannot be used immediately due to the temperature thereof is prevented thanks to the aforementioned technical feature of the metal three-dimensional printer of the invention.

The metal three-dimensional printer of the invention ensures the plastic parts to be attached to the metal parts obtained, without any damage to the metal parts. Here it is the plastic parts that should not be damaged. In the metal three-dimensional printers in the state of the art, high temperatures are reached while melting the metal raw material for the metal object to be printed. It is impossible to couple a high-temperature metal material and a plastic material as the melting temperatures of plastics are much lower than metals. In the metal three-dimensional printer of the invention, during the hitting on a fixed surface on which the metal powder used to print a metal object are ejected, an increase in temperature occurs between the surface and the outer layer of the metal powder as a result of adiabatic heat (the pressure increase at the time of hitting increases the temperature) and partial melting occurs between the metal powder and the fixed surface. Said temperature increase continues up to the melting temperature of the fixed metal surface and powder metal, which is a raw material for printing (660 °C degrees for aluminum), but this temperature increase is measured when the thermal energy required to melt the shell parts is released during the moment of collision of two colliding metal surfaces, and the temperature rapidly decreases to low levels (maximum 100 degrees) thanks to the heat transfer by conduction. As this temperature value will not damage the plastic materials, the plastic-based objects (bushing, pin, body) may be introduced to the printing process when printing the metal objects.

The invention provides a metal three-dimensional printer suitable for use even in a zero-gravity environment. The electromagnetic accelerators used in the metal three-dimensional printer of the invention are calibrated according to the zero-gravity environment and the coordinates to which the metal powder should hit are calculated perfectly. Gravity is only an external factor and causes the raw material of the product to be printed to be deflected during printing. Even when this deviation is eliminated, the printing process may be continued by neutralizing the trans-effect suitable for the deviation value in the printer.

### DESCRIPTION OF THE DRAWINGS

FIG. 1 is a representative view of the metal three-dimensional printer of the invention.

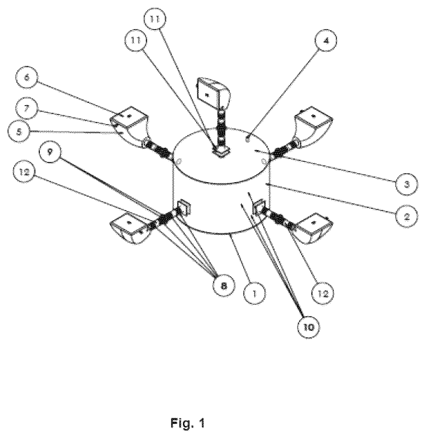

FIG. 2 is a representative top view of the metal three-dimensional printer of the invention.

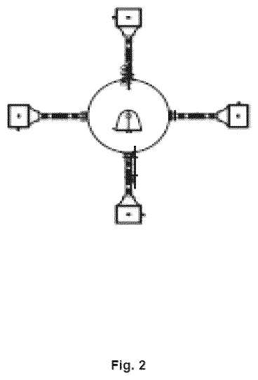

FIG. 3 is an isometric representative cross-sectional view of the metal three-dimensional printer of the invention.

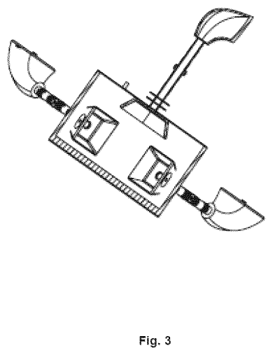

FIG. 4 is a representative view of all components of the metal three-dimensional printer of the invention, which are obtained by making the cylindrical printer wall transparent.

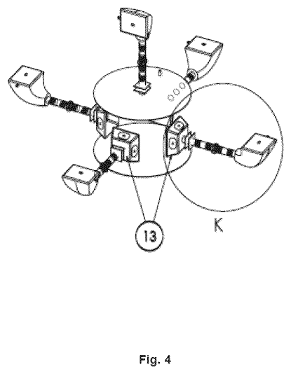

FIG. 5 is a representative K detail view of the powder chamber (5), lid (6), electrode (7), copper coil (8), bundle former (9), electromagnetic deflector (10), high voltage particle accelerator (11), mounting tube (12), mounting body of the electromagnetic deflector (13) of the metal three-dimensional printer of the invention.

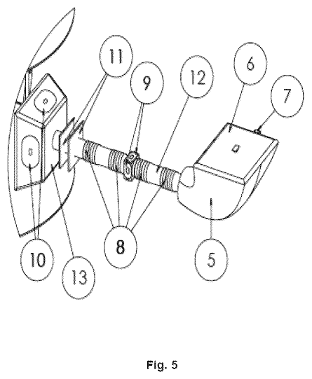

### DESCRIPTION OF THE REFERENCES IN THE DRAWINGS

1. Metal platform
2. Cylindrical printer wall
3. Upper platform
4. Vacuum connection line
5. Powder chamber
6. Lid
7. Electrode
8. Copper coil
9. Bundle former
10. Electromagnetic deflector
11. High voltage particle accelerator
12. Mounting tube
13. Mounting body of the electromagnetic deflector
14.

### DETAILED DESCRIPTION OF THE INVENTION

The invention relates to a metal three-dimensional printer which allows the desired metal parts to be printed faster, makes it possible to obtain stronger metal structures by printing different materials in the same part, prevents the use of extra fasteners to connect the additional parts such as rollers and bearings to a main part, makes it possible to use the printed metal part immediately after printing, increases the strength of the printed part while reducing the weight thereof, and increases the heat emitted during the printing process and thus makes it possible to attach the plastic parts to the metal parts without any damage while printing the metal parts, wherein the metal three-dimensional printer is suitable for domestic use as it does not emit heat, and also for use in gravity and zero-gravity environments and prevents waste of printing raw materials. In the printer of the invention, all metal materials which may be charged with an electric charge and affected by the magnetic field may be used.

The metal three-dimensional printer of the invention comprises:
a metal platform (1) for fixing an object to be printed,
a cylindrical printer wall (2), which functions as a mounting body of a particle accelerator and a printer body,
an upper platform (3), which functions as a mounting body of a particle accelerator, a mounting body of a vacuum connection point, and a printer roof,
at least one vacuum connection line (4), which enables the evacuation of air inside the printer and provides a vacuum environment of at least 80%,
at least one powder chamber (5) which stores a raw material of an object to be printed,
a lid (6) located above the powder chamber (5), through which the metal powders are filled into the powder chamber (5),
at least one electrode (7) which conducts the electric charge from an electric charge generator to the metal powders before entering the particle accelerator,
at least one accelerator coil (8) connected to the powder chamber (5) as a row arranged on a plastic pipe,
at least 3 bundle formers (9), which have electromagnets thereon and arranges the metal powders as bundles of 0.5 mm by pushing the accelerated metal powders on top of each other in the magnetic field generated by the accelerator coils (8),
4 electromagnetic deflectors (10) for each accelerating group, which are mounted on the same line and deflect the metal powders accelerated by the effect of an electromagnetic field and electric charge to the desired coordinates,
2 high-voltage particle accelerators (11) for each accelerating group, which consist of two plates and provides an electric charge to bring the metal powders from the magnetic field in an accelerated form to the collision velocity,
at least one mounting tube (12) of the particle accelerator, which functions as a particle accelerator coil (8) consisting of 1 plastic tube, and a mounting body of the particle accelerator,
A mounting body (13) of the electromagnetic deflector, which deflects the metal powders accelerated by the action of electric charge to the desired coordinates and fixes the electromagnetic deflectors (10).

Said mounting tube (12) is a plastic pipe. In addition, said coil (8) is made of a copper material.

In the metal three-dimensional printer of the invention, the slow speed problem of printing in the metal three-dimensional printers in the state of the art is solved by a multi-point material spraying method. Two types of particle accelerator mechanisms are used in the metal three-dimensional printer of the invention. Said particle acceleration mechanism comprises a coil (8), a bundle former (9), an electromagnetic deflector (10) and a high voltage particle accelerator (11). One of them uses electromagnetism to accelerate the metal particles in a magnetic field. The other particle acceleration mechanism accelerates the particles by providing an electrical charge difference and providing plasma in an environment very close to the vacuum environment. The metal particles reach very high speeds thanks to the particle accelerators (for aluminum, this value is 660 m/s). When a particle with high speed hits a fixed and solid surface, sudden heating occurs between the particle and the surface as the pressure between the particle and the surface increases. This heat causes the particle and fixed surface to melt. The accelerated melted particle causes a crater on the fixed surface, and said particle is embedded in that crater due to its speed, thus accumulating the metal particles on the surface.

The working method of the metal three-dimensional printer of the invention comprises the following process steps:
i. filling the metal powders into a powder chamber (5) through a lid (6) on the powder chamber (5),
ii. charging the metal powders with a negative electric charge from an electrode (7) on the powder chamber (5) by a static electricity generator,
iii. generating a magnetic field by an electrical connection to the accelerator coils (8) connected to the powder chamber (5) as a row arranged on a plastic pipe, and by this magnetic field, creating a force in the center of the coils (8), which pushes the metal powder from the powder chamber (5) to a high voltage particle accelerator (11),
iv. connecting a positive (+) pole electrical cable to two plates containing the high voltage particle accelerator (11) and connecting the electrical cable bearing a negative charge to the lower metal platform (1),
v. supplying an electrical voltage of 1000-100000 V from an electrical source to the high voltage particle accelerator (11) and the lower metal platform (1) and attracting the metal powder in the high voltage particle accelerator (11) towards the center of the metal platform (1) by that voltage difference and creating an electric arc,
vi. in order to form the metal powders as a thin rod before entering the high voltage particle accelerator (11), pushing the negatively charged metal powders on top of each other and towards the center of the bundle formers by the electromagnets on the bundle former (9) located between the copper coils and creating a rod-shaped powder bundle,
vii. starting the printing process by accelerating the metal powders by an acceleration complex on the roof, which comprises the coil (8), bundle former (9), electromagnetic deflector (10) and high-voltage particle accelerator (11), and after that process, printing a skeleton product for the acceleration complexes arranged on the cylindrical printer wall (2),
viii. sending the metal powders onto the printed skeleton product at a high speed by four acceleration complexes arranged on the cylindrical printer wall (2) and after the high-speed metal powders hit the skeleton product, creating a high pressure on the contact points of the metal powders and the skeleton product, and after this pressure is applied, partially melting and intertwining the metallic structures at the contact points of the skeleton product and metal powders,
ix. in order to continue the metal powder accelerating process and to continue directing the metal accumulating process on the skeleton product as long as this process continues so as to obtain the desired geometry, directing the control of the metal accumulation so as to obtain the desired geometry and for this, firstly enabling the electromagnetic deflectors (10) mounted on the same line immediately preceded by the high voltage particle accelerator (11), and sending the accelerated metal powder to the center of the electromagnetic deflector (10) by four coils (8) located on the deflectors (10) and arranged in four directions as right, left, up and down, thereby directing the metal powders by energizing the electromagnets in an area to which the metal powder is desired to be sent.

All process steps are carried out in a vacuum environment of at least 80%. The main source of the problem is the need to melt the raw materials for the object to be printed; especially as the melting temperatures of metals are high, high thermal energy is needed, and as the densities of metals are higher than plastics, etc., they store high thermal energy, so this thermal energy is emitted to the environment during and after the printing process. In my method, instead of melting all of the metal raw material for the object to be printed, melting occurs only on the metal surfaces in the contact area, thus reducing the need for thermal energy and reducing the temperature measured in the environment to safe levels (below 100 degrees). In order to provide this vacuum, a vacuum pump is connected to the vacuum connection line (4) on the upper platform (3) and the air in the printer is evacuated and thus, the desired vacuum environment is provided. The high speed mentioned in process step viii is a speed required to generate the adiabatic heat that the metal to be printed should reach during hitting. There is a characteristic speed for each metal. This speed is 660 m/s for aluminum.

For exemplifying the step ix, if it is desired to send metal powder to a coordinate on the lower right, the right and lower electromagnets are energized and the metal powders are directed to that coordinate.

### REFERENCES

Savunmada “metal YazIcI” dönemi. Dünya Newspaper. (n.d.). https://www.dunya.com/sirketler/savunmada-metal-yazici-donemi-haberi-376401

1. A printer for printing three-dimensional metal materials, characterized in that it comprises:
a metal platform (1) for fixing an object to be printed,
a cylindrical printer wall (2), which functions as a mounting body of a particle accelerator and a printer body,
an upper platform (3), which functions as a mounting body of a particle accelerator, a mounting body of a vacuum connection point, and a printer roof,
at least one vacuum connection line (4), which enables the evacuation of air inside the printer and provides a vacuum environment of at least 80%,
at least one powder chamber (5) which stores a raw material of an object to be printed,
a lid (6) located above the powder chamber (5), through which the metal powders are filled into the powder chamber (5),
at least one electrode (7) which conducts the electric charge from an electric charge generator to the metal powders before entering the particle accelerator,
at least one accelerator coil (8) connected to the powder chamber (5) as a row arranged on a plastic pipe,
at least 3 bundle formers (9), which have electromagnets thereon and arranges the metal powders as bundles of 0.5 mm by pushing the accelerated metal powders on top of each other in the magnetic field generated by the accelerator coils (8),
4 electromagnetic deflectors (10) for each accelerating group, which are mounted on the same line and deflect the metal powders accelerated by the effect of an electromagnetic field and electric charge to the desired coordinates,
2 high-voltage particle accelerators (11) for each accelerating group, which consist of two plates and provides an electric charge to bring the metal powders from the magnetic field in an accelerated form to the collision velocity,
at least one mounting tube (12) of the particle accelerator, which functions as a particle accelerator coil (8) consisting of 1 plastic tube, and a mounting body of the particle accelerator
A mounting body (13) of the electromagnetic deflector, which deflects the metal powders accelerated by the action of electric charge to the desired coordinates and fixes the electromagnetic deflectors (10).

2. A printer according to claim 1, characterized in that said mounting tube (12) is a plastic pipe.

3. A printer according to claim 1, characterized in that said coil (8) is made of a copper material.

4. A working method of a printer to be used in the printing of three-dimensional metal materials, characterized in that it comprises the following process steps:
i. filling the metal powders into a powder chamber (5) through a lid (6) on the powder chamber (5),
ii. charging the metal powders with a negative electric charge from an electrode (7) on the powder chamber (5) by a static electricity generator,
iii. generating a magnetic field by an electrical connection to the accelerator coils (8) connected to the powder chamber (5) as a row arranged on a plastic pipe, and by this magnetic field, creating a force in the center of the coils (8), which pushes the metal powder from the powder chamber (5) to a high voltage particle accelerator (11),
iv. connecting a positive (+) pole electrical cable to two plates containing the high voltage particle accelerator (11) and connecting the electrical cable bearing a negative charge to the lower metal platform (1),
v. supplying an electrical voltage of 1000-100000 V from an electrical source to the high voltage particle accelerator (11) and the lower metal platform (1) and attracting the metal powder in the high voltage particle accelerator (11) towards the center of the metal platform (1) by that voltage difference and creating an electric arc,
vi. in order to form the metal powders as a thin rod before entering the high voltage particle accelerator (11), pushing the negatively charged metal powders on top of each other and towards the center of the bundle formers by the electromagnets on the bundle former (9) located between the copper coils and creating a rod-shaped powder bundle,
vii. starting the printing process by accelerating the metal powders by an acceleration complex on the roof, which comprises the coil (8), bundle former (9), electromagnetic deflector (10) and high-voltage particle accelerator (11), and after that process, printing a skeleton product for the acceleration complexes arranged on the cylindrical printer wall (2),
viii. sending the metal powders onto the printed skeleton product at a high speed by four acceleration complexes arranged on the cylindrical printer wall (2) and after the high-speed metal powders hit the skeleton product, creating a high pressure on the contact points of the metal powders and the skeleton product, and after this pressure is applied, partially melting and intertwining the metallic structures at the contact points of the skeleton product and metal powders,
ix. in order to continue the metal powder accelerating process and to continue directing the metal accumulating process on the skeleton product as long as this process continues so as to obtain the desired geometry, directing the control of the metal accumulation so as to obtain the desired geometry and for this, firstly enabling the electromagnetic deflectors (10) mounted on the same line immediately preceded by the high voltage particle accelerator (11), and sending the accelerated metal powder to the center of the electromagnetic deflector (10) by four coils (8) located on the deflectors (10) and arranged in four directions as right, left, up and down, thereby directing the metal powders by energizing the electromagnets in an area to which the metal powder is desired to be sent.

5. A working method according to claim 4, characterized in that in all of the process steps i-ix, a vacuum pump is connected to the vacuum connection line (4) in the printer and the air inside the printer is evacuated to provide a vacuum environment of at least 80%.

6. A working method according to claim 4, characterized in that said coil (8) is made of a copper material.
